(19) United States
(12) Patent Application Publication
(10) Pub. No.: US 2025/0316047 A1
(43) Pub. Date: Oct. 9, 2025

(54) AUTOMATIC LABELING OF SENSOR REPRESENTATIONS FOR MACHINE LEARNING SYSTEMS AND APPLICATIONS

(71) Applicant: NVIDIA Corporation, Santa Clara, CA (US)

(72) Inventors: Austin Martin, Larkspur, CA (US); Jacob Meyer, Honolulu, HI (US); James Skinner, Arvada, CO (US); Tilman Wekel, San Jose, CA (US)

(21) Appl. No.: 18/629,496

(22) Filed: Apr. 8, 2024

(51) Int. Cl. G06V 10/22; G06V 10/94; G06V 20/58

(52) U.S. Cl. CPC G06V 10/235; G06V 10/945; G06V 20/58

(57) ABSTRACT

In various examples, automatic labeling of sensor representations for machine learning systems and applications. Systems and methods described herein may receive inputs for labeling one or more sensor representations of sensor data that represent objects or features, and then use those labels to automatically label additional sensor representations that also represent the same objects or features. For instance, and for an object, a user interface may include at least a map indicating a trajectory of the object, one or more sensor representations which represent the object, and a timeline indicating a time period for which the object was detected. A user may then use the user interface to label the object, such as with a bounding shape indicating a location of the object and/or with one or more attributes describing the object.

### BACKGROUND

Labeling sensor data may be important for many applications, such as to generate training data that is later used to train machine learning models to perform specific tasks (e.g., object recognition, object tracking, trajectory planning, etc.). As such, conventional systems may provide tools to allow users (e.g., labelers) to label certain frames of sensor data. For example, and for sensor data representing multiple frames, a system may cause user devices to display user interfaces that include certain keyframes from the sensor data, where these keyframes represent objects located within an environment. Users may then use these user devices to provide inputs indicating the locations of the objects within the keyframes, such as in the form of 2D bounding shapes (e.g., for two-dimensional labeling) and/or 3D bounding volumes (e.g., cuboids for three-dimensional labeling). The system may then use these labeled keyframes to generate ground truth data and/or to perform other processes.

However, requiring users to individually label each of the keyframes of sensor data may require large amounts of human resources, time, and/or computing resources. This is because one stream of sensor data may include hundreds and/or thousands of keyframes, where each keyframe may include one or more objects that need to be labeled. Additionally, by only labeling keyframes, many other frames of the sensor data may not be labeled, which may reduce the overall amount of training data that the conventional systems are able to produce. Furthermore, different users may label objects differently, such as by inputting 2D and/or 3D bounding shapes that do not include accurate dimensions for the objects and/or are not located at the accurate locations/poses/orientations within the keyframes. In many circumstances, inaccurate labeling the senor data may cause further problems, such as when used for training machine learning models, as the machine learning models may not be trained to produce outputs that are as accurate or precise as desired or required for a particular application.

### SUMMARY

Embodiments of the present disclosure relate to automatic labeling of sensor representations—e.g., images, point clouds, top-down or bird's eye view (BEV) occupancy representations, etc.—for machine learning systems and applications. Systems and methods described herein may use a user interface to receive inputs for labeling sensor representations of sensor data that represent objects and/or features at first time instances, and then may use those labels to automatically label additional sensor representations that also represent the same objects and/or features at second time instances. For instance, and for an object, the user interface may include at least a map indicating location information associated with the object within the environment, one or more sensor representations which represent the object and are associated with a time instance, and a timeline indicating a time period for which the object was detected. A user may then use the user interface to label the object, such as with one or more bounding shapes indicating the location of the object, the orientation of the object, and/or dimensions of the object, and/or with one or more attributes describing the object. At least a portion of these labels may then be used to automatically label additional sensor representations that also represent the object (e.g., using interpolation, etc.), where the additional sensor representations are associated additional time instances (e.g., before and/or after the time instance).

As such, and in contrast to conventional systems, the systems of the current disclosure, in some embodiments, are able to use user labels provided for an object and/or feature for a sensor representation associated with a time instance to then automatically label additional sensor representations that also represent the object and/or feature and are associated with additional time instances. This may reduce the amount of human resources and time required, as well as the computing resources required as compared to conventional systems which may require users to manually label each instance of the sensor representations with labels for the same object. Additionally, and for similar reasons, the systems of the current disclosure may produce more accurate labels for sensor representations since the labeling is less prone to user error.

Furthermore, in contrast to the conventional systems, in some embodiments and for similar reasons, the systems and methods described herein are able to label more sensor representations (e.g., all sensor representations) included in a sequence of sensor representations by automatically interpolating labels between the sensor representations. This provides improvements over the conventional systems in which only specific sensor representations are labeled, such as just the keyframes. For example, by labeling additional sensor representations, and as described more herein, the systems of the present disclosure are able to better track objects and/or features over periods of time and/or are able to generate larger amounts of training data for training machine learning models.

### BRIEF DESCRIPTION OF THE DRAWINGS

The present systems and methods for automatic labeling of sensor representations for machine learning systems and applications are described in detail below with reference to the attached drawing figures, wherein:

FIG. 1 illustrates an example data flow diagram for a process of automatically labeling sensor representations using a user interface, in accordance with some embodiments of the present disclosure;

FIGS. 2A-2B illustrate examples of a user interface that includes information associated with objects located within an environment, in accordance with some embodiments of the present disclosure;

FIGS. 3A-3B illustrate an example of using a user interface to update labels associated with an object, in accordance with some embodiments of the present disclosure;

FIGS. 4A-4B illustrate an example of using updated labels for sensor representations associated with a time instance to update labels for sensor representations associated with an additional time instance, in accordance with some embodiments of the present disclosure;

FIGS. 5A-5B illustrate an example of using a user interface to generate labels for an object, in accordance with some embodiments of the present disclosure;

FIGS. 6A-6B illustrate examples of updating trajectories of an object based at least on user input, in accordance with some embodiments of the present disclosure;

FIG. 7 illustrates a data flow diagram illustrating a process for training one or more machine learning models to perform one or more tasks, in accordance with some embodiments of the present disclosure

FIG. 8 illustrates a flow diagram showing a method for automatically labeling sensor representations corresponding to an object, in accordance with some embodiments of the present disclosure;

FIG. 9 illustrates a flow diagram showing a method for using automatically determined labels to determine a trajectory associated with an object, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

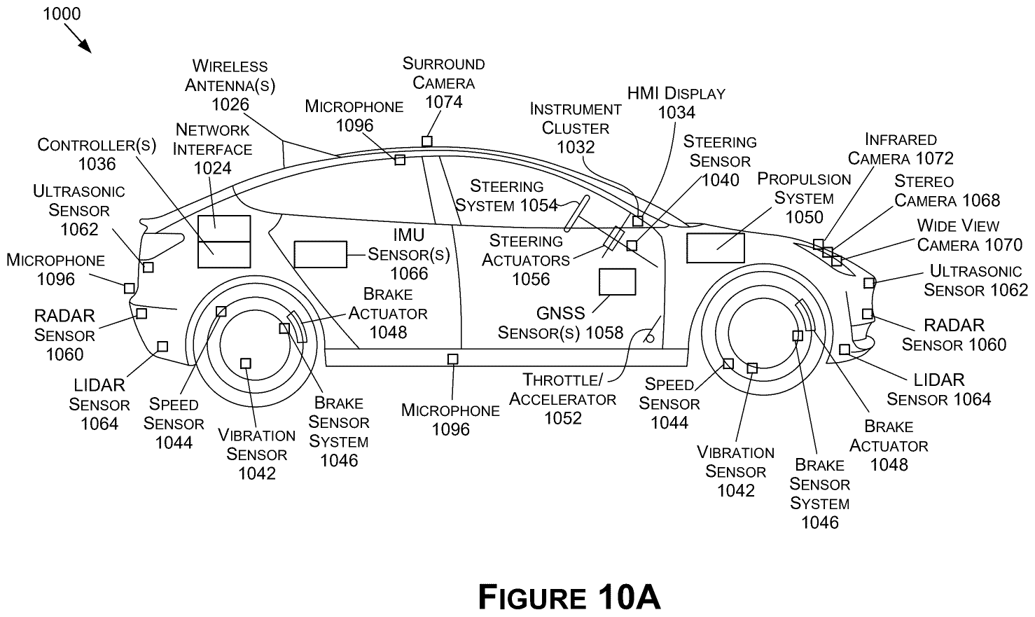

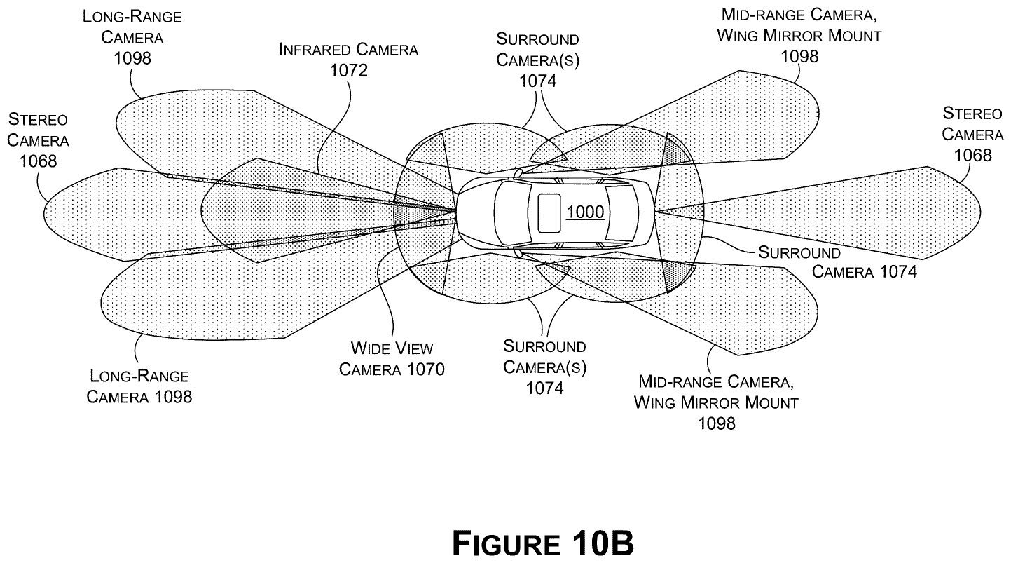

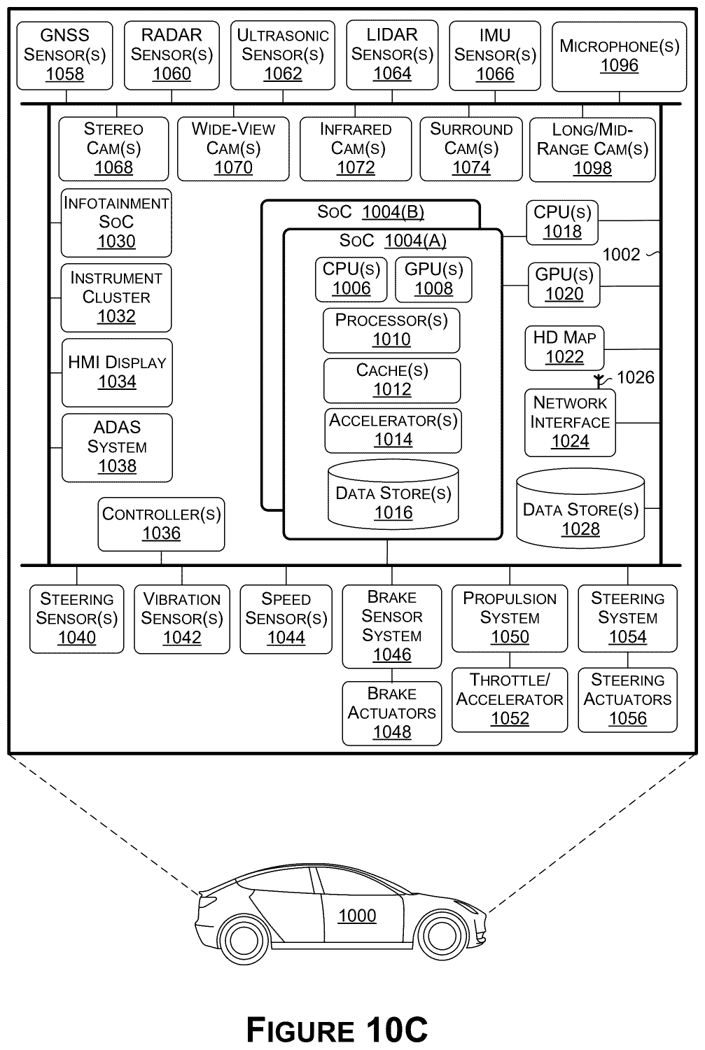

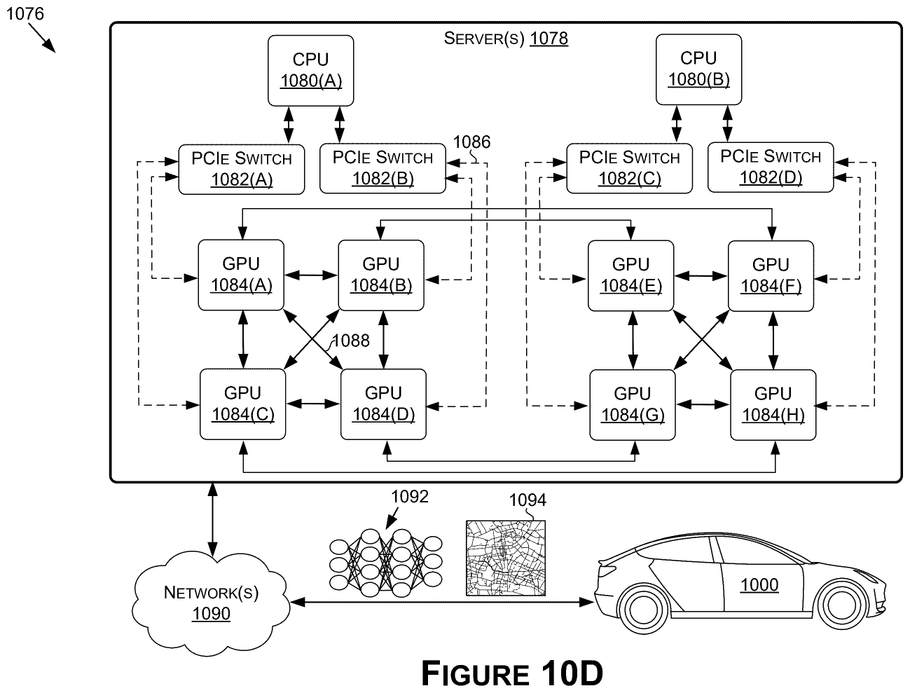

Systems and methods are disclosed related to automatic labeling of sensor representations for machine learning systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to labeling sensor data, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may receive sensor data generated using one or more sensors of one or more machines (e.g., one or more data capturing machines) navigating within an environment. As described herein, the sensor data may include, but is not limited to, LiDAR data generated using one or more LiDAR sensors, image data generated using one or more image sensors (e.g., one or more cameras), RADAR data generated using one or more RADAR sensors, ultrasonic data generated using one or more ultrasonic sensors, and/or any other type of sensor data generated using any other type of sensor. In some examples, the system(s) may then process the sensor data, such as by using one or more machine learning models, in order to generate labels (referred to, in some examples, as “initial labels”) for sensor representations (e.g., frames, such as image frames, point cloud frames, etc.) of the sensor data. As described herein, a label for an object may include, but is not limited to, location information, such as a position within an environment (e.g., the x-coordinate location, the y-coordinate location, and/or the z-coordinate location), an orientation within the environment (e.g., the roll, the pitch, and/or the yaw), a bounding shape (e.g., a two-dimensional bounding shape, a three-dimensional bounding shape, etc.), and/or any other type of location information, and/or one or more attributes, such as a classification, a sub-classification, motion information (e.g., static, dynamic, velocity, acceleration, etc.), attachments (e.g., trailers, etc.), and/or any other type of attribute associated with an object.

As described herein, in some examples, an object may include, but is not limited to, a vehicle (e.g., a car, a van, a truck, a motorcycle, etc., a pedestrian, a structure, a feature, an animal, and/or any other type of object. Additionally, in some examples, a feature may include, but is not limited to, a traffic feature, such as a traffic pole, a traffic sign, a traffic signal, a traffic line (e.g., a road line, a crosswalk line, a stopping line, etc.), a parking space, and/or any other type of traffic feature.

The system(s) may then generate and/or present a user interface that not only provides information to one or more users, but also allows the user(s) to generate and/or update labels. For instance, the user interface may include at least a map of the environment that includes information associated with objects detected using the sensor data. For example, the map may include at least positions of the objects at a specific time instance, orientations of the objects at the specific time instance, trajectories of the objects over time periods for which the objects were detected, and/or any other information. In some examples, the map may be associated with a specific type of sensor data, such as LiDAR data. For example, the map may represent the locations of points located within the environment as represented by the LiDAR data. Additionally, the user interface may include a timeline indicating the time periods for which the objects were detected within the environment. For example, the timeline may indicate a first time period that a first object was detected, a second time period that a second object was detected, a third time period that a third object was detected, and/or so forth.

The system(s) may then cause a user device to provide the user interface to the user(s). In some examples, the user(s) may then move through an entire time period associated with the sensor data in order to see how the objects moved throughout the environment. For example, if the user(s) selects a new time instance, the map may update to indicate the positions and/or orientations of the objects at the new time instance. Additionally, in some examples, the information associated with the environment as represented by the specific sensor data may update, such as by showing additional points represented by the LiDAR data that were generated at approximately the new time instance. The user(s) may also select an object for viewing sensor representations associated with the object and/or for updating the labels associated with the sensor representation.

For instance, based at least on selecting an object, the system(s) may cause the user interface to update in order to present sensor representations that represent the object and are associated with the current time instance selected by the user(s). For example, the sensor representations may include at least a first sensor representation associated with LiDAR data and representing the object in a first orientation (e.g., from the side), a second sensor representation associated with LiDAR data and representing the object in a second orientation (e.g., from the front), and a third sensor representation associated with image data and representing the object as captured by an imaging device (e.g., a camera) that includes the best view of the object. While this is just one example of the types of sensor representations that may be presented by the user interface, in other examples, one or more additional and/or alternative types of sensor representations may be presented by the user interface. The user(s) may then use the user interface to perform one or more processes, such as verifying whether labels are correct, updating labels that are not correct, adding labels that are missing, deleting labels that are not necessary and/or incorrect, and/or performing any other type of process associated with the labels.

For instance, and using the example above, the first sensor representation may be associated with a first bounding shape associated with the first orientation of the object and the second sensor representation may be associated with a second bounding shape associated with the second orientation of the object. As such, if the bounding shapes are correct, then the user(s) may not update the bounding shapes and/or may provide one or more inputs indicating that the bounding shapes are correct. However, if at least one of the bounding shapes is incorrect, then the user(s) may provide inputs for updating the bounding shape(s) to more accurately represent the object. For example, the user(s) may provide inputs for updating one or more dimensions associated with the bounding shape(s). In some examples, based at least on the update to the bounding shape(s), the system(s) may then further update a third bounding shape associated with the third sensor representation in order to match the updated bounding shape(s), such as to match the dimensions. This way, the user(s) may only need to update the bounding shape(s) for the time instance and then the system(s) may automatically update the other bounding shape(s).

As described herein, in some examples, the same object may be represented by additional sensor representations that are associated with additional time instances, such as before and/or after the current time instance. As such, the system(s) may also use the updates to the bounding shape(s) to further update one or more bounding shapes associated with the additional sensor representations that also represent the object. In some examples, the system(s) updates the additional bounding shape(s) using one or more techniques, such as by interpolating between the sensor representations and/or using the motion of the machine(s)—e.g., ego-motion—that generated the sensor data. In some examples, the system(s) may update all of the sensor representations that also represent the object. However, in some examples, the system(s) may only update specific sensor representations, such as sensor representations that are within a threshold time period to the current sensor representation, within a threshold distance traveled prior to or after the particular sensor representations, and/or within a threshold number of sensor representations to the sensor representation. For example, the system(s) may update sensor representations that were generated during a previous time period and/or sensor representations that were generated during a future time period.

In some examples, in addition to, or alternatively from, updating the location information associated with the object, the system(s) may update one or more attributes associated with the object. For example, along with the sensor representations associated with the current time instances, the user interface may present one or more attributes associated with the object as represented by the sensor representations. The user(s) may then use the user interface to generate one or more new attributes associated with the object, verify the initial attribute(s) associated with the object, update the initial attribute(s) associated with the object, delete attributes associated with the object, and/or perform any other process associated with the attributes. If the user(s) generates a new attribute(s) associated with the object and/or updates an initial attribute(s) associated with the object, then the system(s) may again use these updates to update the additional sensor representations that also represent the object. For example, the system(s) may associate the same generated attribute(s) and/or the same updated attribute(s) with the additional sensor representations. As such, by performing the processes described herein, the user(s) may only need to update labels for one or more sensor representations and then the system(s) may use those updates to generate and/or update labels association with additional sensor representations.

In some examples, the system(s) may allow the user(s) to update additional labels associated with the object using the user interface. For instance, and as described herein, along with the sensor representations associated with the current time instance, the user interface may present a map that indicates a position and/or an orientation of the object within the environment at the current time instance, such as in the form of another bounding shape. As such, if the position and/or the orientation is incorrect, the user(s) may use the user interface to update the location and/or the orientation, such as by providing one or more inputs to update the bounding shape. The system(s) may then use the updated position and/or orientation to further update the trajectory associated with the object. Additionally, based at least on the labels associated with the other time instances for which the object was detected, the system(s) may perform these processes to generate a full trajectory, which may be referred to as a trackline, associated with the object within the environment.

In some examples, the system(s) may perform additional and/or alternative processes using the user interface. For a first example, the user(s) may use the user interface to generate one or more labels for a new object represented by the sensor data. When generating the new label(s), the user(s) may use the user interface to (1) generate labels for multiple sensor representations that represent the object and/or (2) generate the label(s) for one or more of the sensor representations, and then the system(s) may automatically generate the additional labels for the additional sensor representations using the inputted label(s). For a second example, the user(s) may indicate whether an object includes a static object and/or a dynamic object and, in response, the system(s) may perform one or more operations. For instance, if the user(s) indicates that an object is static, then the system(s) may update the trajectory associated with the object to includes a point within the environment.

For a third example, the user interface may include a trajectory for an object that is incomplete. For instance, the user interface may include, in addition to the trajectory, additional information associated with the object being detected using the sensor data, such as points associated with the object as represented by the sensor data. As such, the user(s) may provide one or more inputs indicating that the trajectory is incomplete, such as by selecting the additional information associated with the object. Based at least on the input(s), the system(s) may then update the trajectory using the additional information. For example, if the additional information is associated with a location within the environment, then the system(s) may extend the trajectory to be located proximate to the location within the environment.

In some examples, the system(s) may perform one or more additional operations using the sensor data, such as after the updating. For instance, the system(s) may use the sensor data to generate training data for one or more machine learning models. For a first example, if a machine learning model is being trained using images depicting objects, then the system(s) may use the image data to generate images that are labeled with at least a portion of the generated and/or updated labels. For a second example, if a machine learning model is being trained using point clouds representing objects, then the system(s) may use the LiDAR data to generate point cloud frames that are labeled with at least a portion of the generated and/or updated labels. While these are just a few examples of training data that the system(s) may generate using the labeled sensor data, in other examples, the system(s) may generate additional and/or alternative types of training data using the labeled sensor data.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

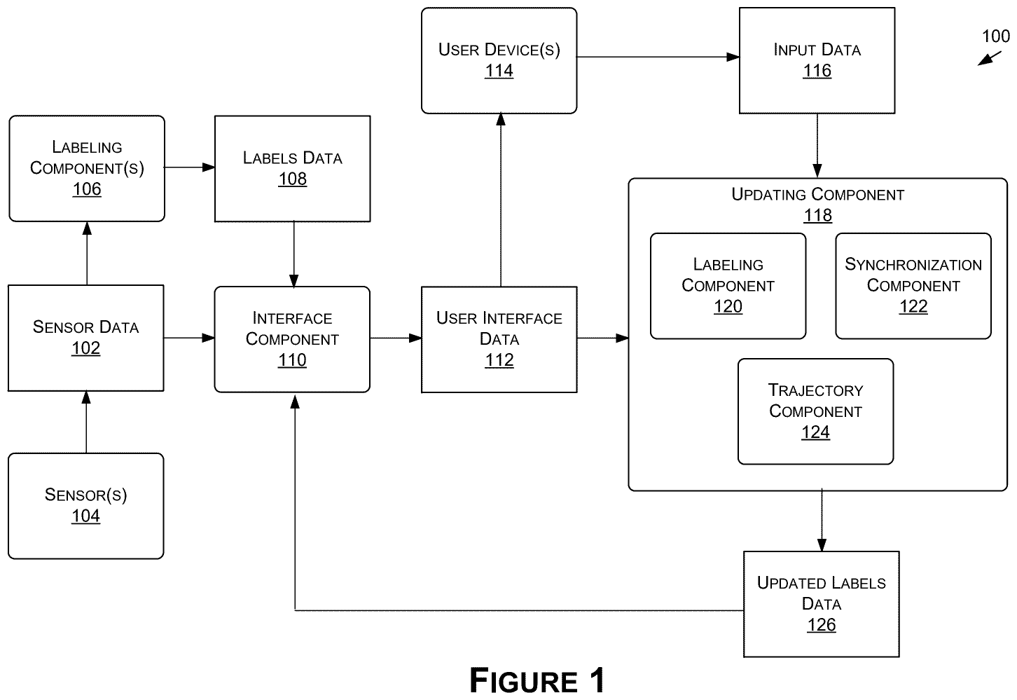

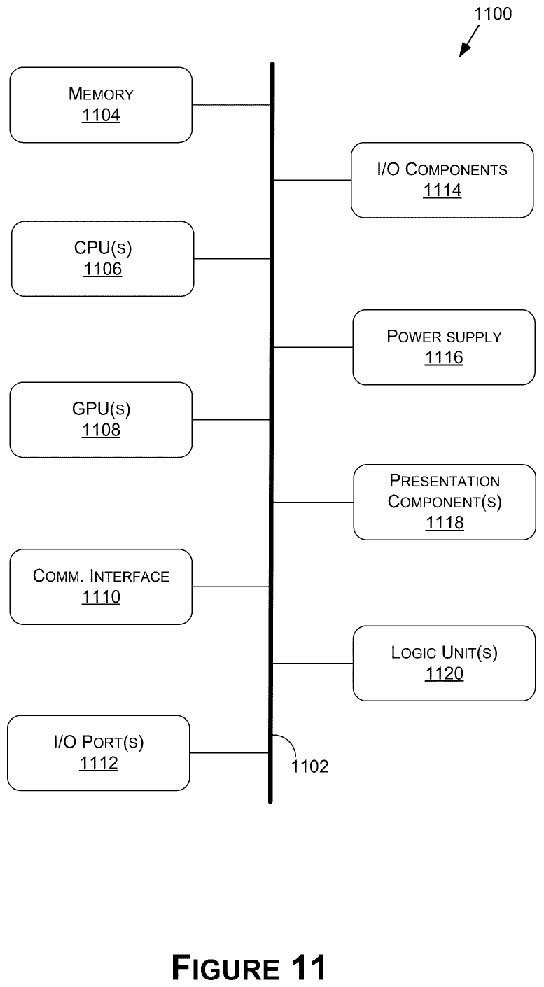

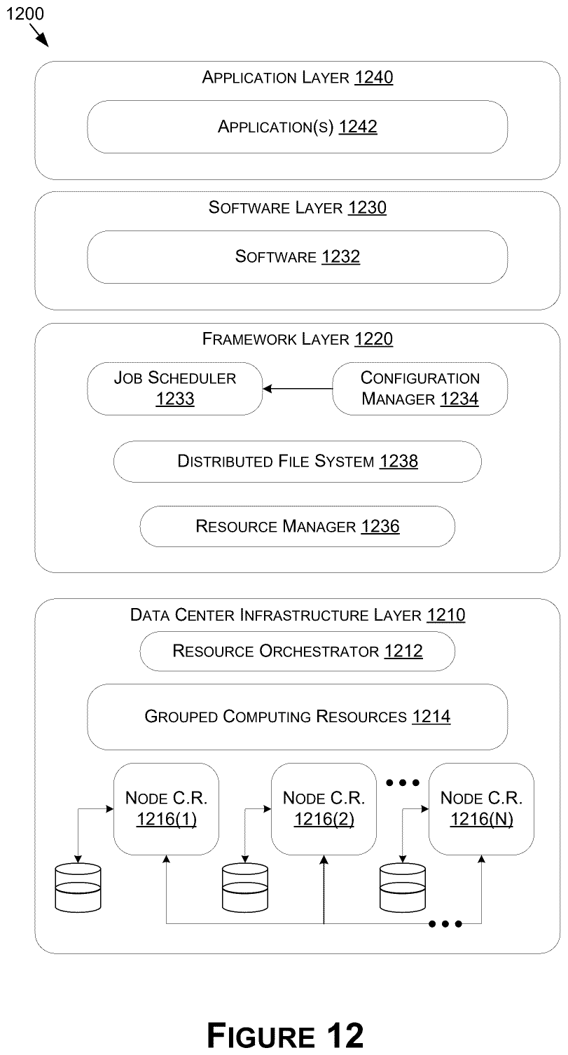

With reference to FIG. 1, FIG. 1 illustrates an example data flow diagram for a process 100 of automatically labeling sensor representations using a user interface, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may include generating sensor data 102 using one or more sensors 104 of one or more machines (e.g., one or more autonomous vehicles 1000). As described herein, the sensor data 102 may include, but is not limited to, LiDAR data generated using one or more LiDAR sensors, image data generated using one or more image sensors (e.g., one or more cameras), RADAR data generated using one or more RADAR sensors, ultrasonic data generated using one or more ultrasonic sensors, and/or any other type of sensor data generated using any other type of sensor. As described herein, the sensor data 102 may represent sensor representations, such as frames, point clouds, and/or any other type of representation associated with sensor data 102. For example, the sensor data 102 may represent image frames, LiDAR frames, a LiDAR point cloud, and/or so forth.

In some examples, and as illustrated by the example of FIG. 1, the process 100 may then include using one or more labeling components 106 to process at least a portion of the sensor data 102 and, based at least on the processing, generating labels data 108 representing labels associated with the sensor data. As described herein, the labeling component(s) 106 may include, and/or may use, one or more machine learning models, one or more neural networks, one or more algorithms, one or more modules, and/or any other type of processing component that is able to process the sensor data 102 and generate the labels data 108. For example, the labeling component(s) 106 may include, and/or use, an object detection model, an object tracking model, an object classification model, a perception model, and/or so forth.

Additionally, the labels data 108 may represent initial labels for the sensor data 102 that are later analyzed by one or more users to verify whether the labels are accurate and/or to update when the labels are not accurate. As described herein, labels may include, but are not limited to, locations of objects as represented by the sensor data 102, attributes of objects as represented by the sensor data 102, and/or any other type of label associated with objects. For instance, a label associated with a location may include, but is not limited to, a position of an object (e.g., the x-coordinate location, the y-coordinate location, and/or the z-coordinate location), an orientation or pose of the object (e.g., the roll, the pitch, and/or the yaw), a bounding shape (e.g., a two-dimensional bounding shape, a three-dimensional bounding shape) associated with the object as represented by a sensor representation, and/or any other location information associated with the object. When describing a bounding shape, the bounding shape may include any type of shape, such as a circle, a square, a rectangle, a polygon, a pentagon, a cube, a cuboid, a bounding volume, and/or any other shape. Additionally, a label associated with an attribute may include, but is not limited to, a classification (e.g., vehicle, pedestrian, animal, road, sidewalk, structure, etc.), a sub-classification (e.g., car, truck, van, and/or the like for vehicles), additional components (e.g., whether a vehicle includes a tractor, etc.), a state (e.g., whether doors of a vehicle are shut or open, etc.), motion information (e.g., static object, dynamic object, a velocity, an acceleration, a direction of travel, etc.), and/or any other type of attribute associated with an object.

The process 100 may include an interface component 110 using at least a portion of the sensor data 102 and/or at least a portion of the labels data 108 in order to generate user interface data 112 representing one or more user interfaces. As described herein, a user interface may be used to provide one or more users with information associated with the environment. For example, the user interface may include at least a map of the environment indicating location information (e.g., positions, orientations, trajectories, etc.) of objects over a time period, one or more sensor representations that represent the objects, a timeline that indicates time periods that the objects were detected within the environment, and/or any other information associated with the objects. Additionally, if the interface component 110 receives the labels data 108 from the labeling component(s) 106, then the user interface may further include at least a portion of the labels associated with the objects. This way, the user(s) is able to use the user interface to verify whether labels are correct, update labels that are not correct, add labels that are missing, delete labels that are not necessary and/or incorrect, and/or perform any other type of process associated with the labels.

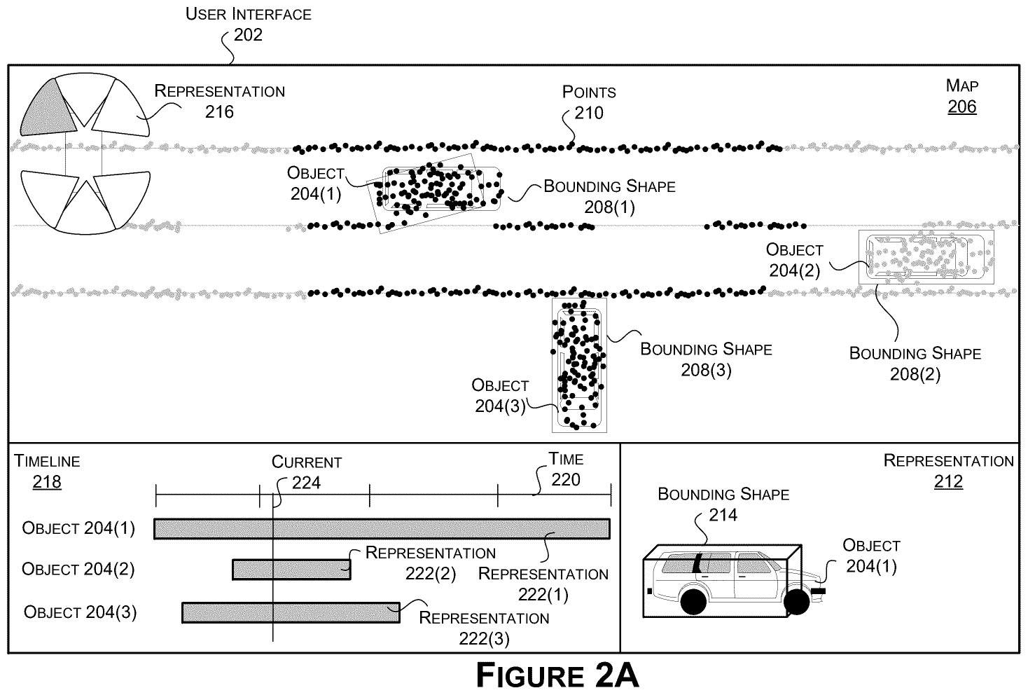

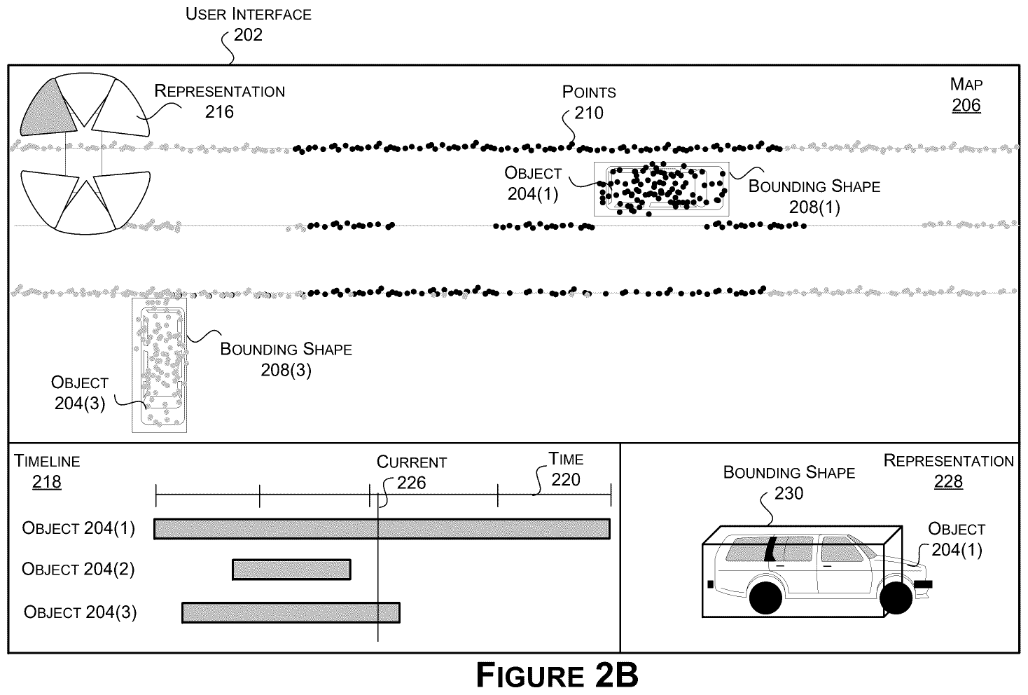

For instance, FIG. 2A illustrates an example of a user interface 202 that includes information associated with objects 204(1)-(3) (also referred to singularly as “object 204” or in plural as “objects 204”) located within an environment, in accordance with some embodiments of the present disclosure. As shown, the user interface 202 may include at least a map 206 of the environment that indicates the positions of the objects 204 using bounding shapes 208(1)-(3) (also referred to singularly as “bounding shape 208” or in plural as “bounding shapes 208”). In some examples, the bounding shapes 208 may be determined using the labels data 108, such that the bounding shapes 208 include initial bounding shapes that may be verified and/or updated. The map 206 further includes points 210 (although only one is labeled) associated with sensor data, such as LiDAR data.

In the example of FIG. 2A, the points 210 may include different characteristics based at least on one or more factors. For example, first points 210 may include one or more first characteristics, such as one or more first colors (e.g., dark colors, such as black), based at least on the first points 210 being generated at a current time instance that is selected for the user interface 202. For instance, the first points 210 may be represented by first LiDAR data generated proximate to the current time instance. Additionally, second points 210 may include one or more second characteristics, such as one or more second colors (e.g., light colors, such as grey), based at least on the second points 210 being generated at other time instances associated with the user interface 202. For instance, the second points 210 may be represented by second LiDAR data generated either before and/or after the current time instance. In some examples, the characteristics of the points 210 change more the further away from the current time instance for which the points 210 were generated. For instance, the points 210 may continue to get lighter in color the further away the points were generated in time as compared to the current time instance. While the example of FIG. 2A illustrates the characteristics as including colors, in other examples, other types of characteristics may be used, such as shapes, patterns, shadings, and/or the like.

The user interface 202 may further include at least one sensor representation 212 generated approximate to the current time instance. While the example of FIG. 2A illustrates the sensor representation 212 as including a frame of image data, in other examples, the sensor representation 212 may be associated with any other type of sensor data. Additionally, as shown, the sensor representation 212 depicts the first object 204(1) and is associated with another bounding shape 214 associated with the first object 204(1). In some examples, the bounding shape 214 may be determined using the labels data 108, such that the bounding shape 214 includes an initial bounding shape that may be verified and/or updated.

The user interface 202 may further include a virtual representation 216 of a machine that generated the sensor data associated with the user interface 202 and/or the sensor representation 212. In some examples, the virtual representation 216 may also be referred to as an avatar representing the machine. As shown, the virtual representation 216 may indicate fields of view (FOVs) associated with sensors of the machine, such as image sensors, LiDAR sensors, and/or RADAR sensors, which are represented by the cone shapes. Additionally, the virtual representation 216 may indicate which sensor generated the sensor data associated with the sensor representation 212, such as by using shading associated with the FOVs. For instance, and in the example of FIG. 2A, the virtual representation 216 may indicate that the front-right image sensor generated the sensor representation 212.

As further illustrated by the example of FIG. 2A, the user interface 202 may further include a timeline 218 that indicates at least a time period 220 associated with the sensor data. Additionally, the timeline 218 includes at least a first representation 222(1) indicating a first time period that the first object 204(1) was detected, a second representation 222(2) indicating a second time period that the second object 204(2) was detected, and a third representation 222(3) indicating a third time period that the third object 204(3) was detected. Furthermore, the timeline 218 includes an indication of a current time instance 224 that is being represented by the user interface 202. As described herein, the timeline 218 may be used to move to different time instances associated with the sensor data.

For instance, FIG. 2B illustrates an example of the user interface 202 that includes additional information associated with the objects 204 located within the environment, in accordance with some embodiments of the present disclosure. As shown, at a new current time instance 226, the map 206 may be updated to indicate the current positions of the first object 204(1) and the third object 204(3) which were still detected, where the current positions are still indicated respectively by the bounding shape 208(1) and the bounding shape 208(3). Additionally, the characteristics associated with the points 210 may be updated in order to indicate which points are associated with the new current time instance 226 and which points are associated with other time instances (e.g., either before or after the new current time instance 226). Furthermore, the user interface 202 may include a new sensor representation 228 associated with the new current time instance 226, where the sensor representation 228 again depicts the first object 204(1) and is associated with a new bounding shape 230 associated with the first object 204(1).

Referring back to the example of FIG. 1, the process 100 may include providing the user interface data 112 to one or more user devices 114 associated with the user(s). As described herein, based at least on receiving the user interface data 112, the user device(s) 114 may present the user interface to the user(s), as represented by one or more of the examples described herein (e.g., FIGS. 2A-5B). The user interface may then allow the user(s) to perform one or more processes, such as verifying whether labels are correct, updating labels that are not correct, adding labels that are missing, deleting labels that are not necessary and/or incorrect, and/or performing any other type of process associated with the labels. In some examples, the user(s) is able to perform one or more of these processes by providing one or more inputs to the user device(s) 114, where the input(s) is represented by input data 116. As described herein, the user device(s) 114 may include any type of input device that allows the user(s) to provide the input(s), such as a keyboard, a mouse, a touch-sensitive display, a pad, a roller, a microphone, a camera, and/or the like.

For instance, based at least on the user(s) selecting an object, the user device(s) 114 may cause the user interface to update in order to present sensor representations that represent the object and are associated with the current time instance. For example, the sensor representations may include at least a first sensor representation associated with LiDAR data and representing the object in a first orientation (e.g., from the side), a second sensor representation associated with LiDAR data and representing the object in a second orientation (e.g., from the front), and a third sensor representation associated with image data and representing the object as captured by an imaging device (e.g., a camera) that includes the best view of the object. While this is just one example of the types of sensor representations that may be presented using the user interface, in other examples, one or more additional and/or alternative types of sensor representations may be presented using the user interface. The user(s) may then use the user interface to at least generate labels for the object, verify the initial labels for the object, and/or update the initial labels for the object.

For instance, and using the example above, the first sensor representation may be associated with a first bounding shape associated with the first orientation of the object and the second sensor representation may be associated with a second bounding shape associated with the second orientation of the object. As such, if the bounding shapes are correct, then the user(s) may not update the bounding shapes and/or may provide input indicating that the bounding shapes are correct. However, if at least one of the bounding shapes is incorrect, then the user(s) may provide inputs for updating the bounding shape(s) to more accurately represent the object. For example, the user(s) may provide inputs for updating one or more dimensions associated with the bounding shape(s). In some examples, based at least on the update to the bounding shape(s), the process 100 may include using an updating component 118 to further update a third bounding shape associated with the third sensor representation in order to match the updated bounding shape(s), such as to match the dimensions of the updated bounding shape(s). This way, the user(s) may only need to update one bounding shape for the current time instance and then the updating component 118 may automatically update the other bounding shape(s).

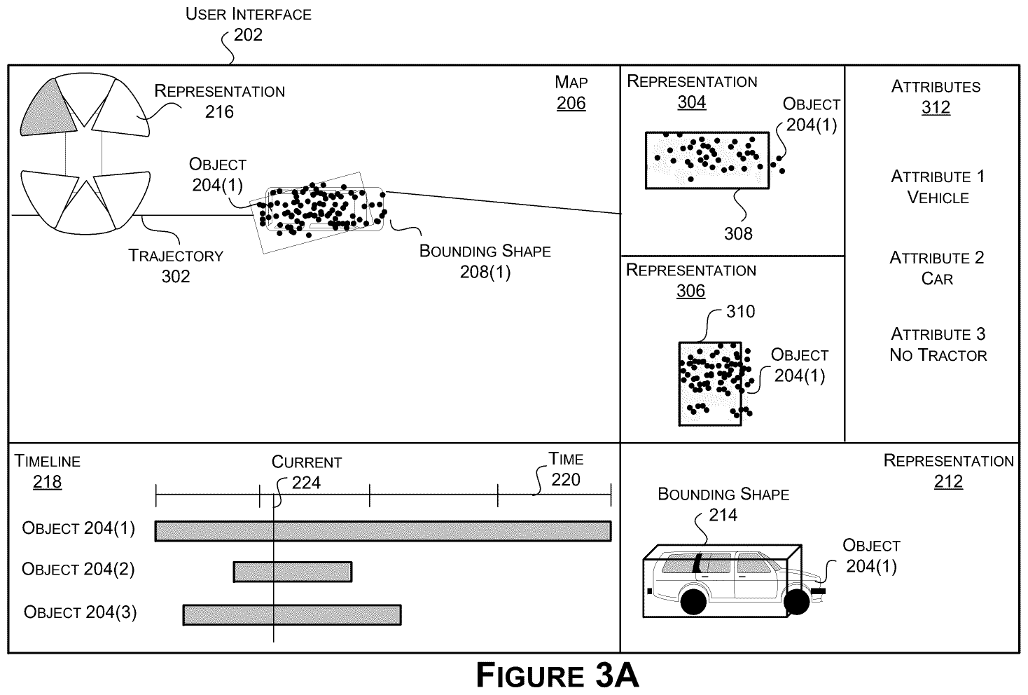

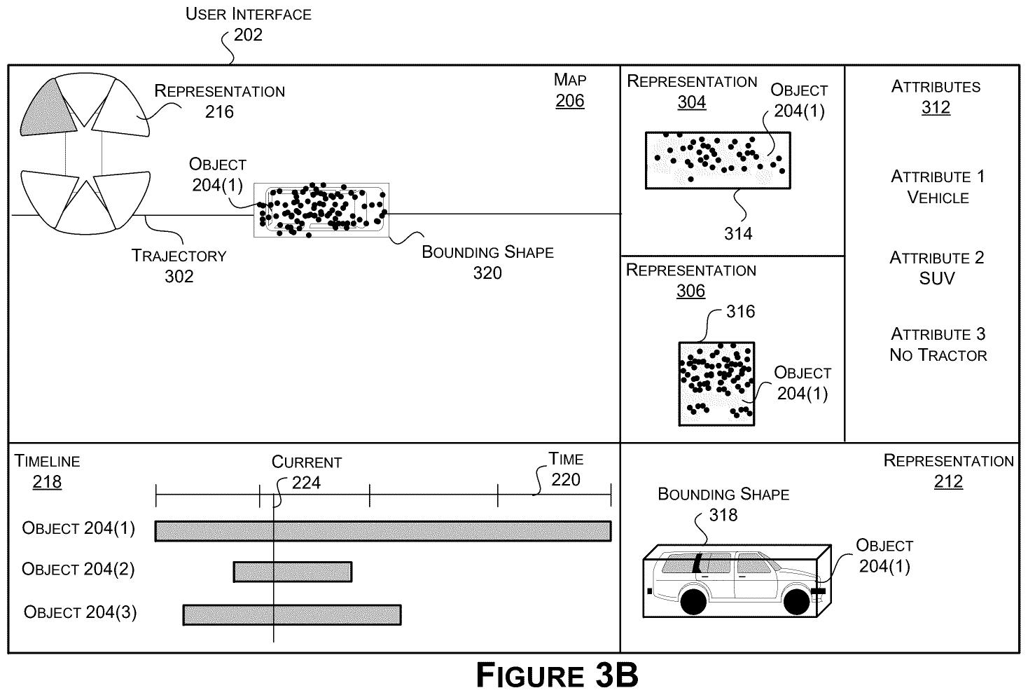

For instance, FIGS. 3A-3B illustrate an example of using the user interface 202 to update labels associated with the first object 204(1), in accordance with some embodiments of the present disclosure. As shown by the example of FIG. 3A, based at least on the user(s) selecting the first object 204(1), such as by selecting the first representation 222(1) and/or the first bounding shape 208(1) associated with the first object 204(1), the user interface 202 may update the map 206 to indicate at least the position of the first object 204(1) at the current time instance 224, the orientation of the first object 204(1) at the current time instance 224, and an indication (e.g., a trackline) associated with a trajectory 302 of the first object 204(1).

The user interface 202 may also present a sensor representation 304 associated with LiDAR data and representing the first object 204(1) in a first orientation, such as from the side, and a sensor representation 306 associated with the LiDAR data and representing the first object 204(2) in a second orientation, such as from the front or the back. As shown, the sensor representation 304 may be associated with a bounding shape 308 (e.g., an initial bounding shape) associated with the first object 204(1) in the first orientation and the sensor representation 306 may be associated with a bounding shape 310 (e.g., an initial bounding shape) associated with the first object 204(2) in the second orientation.

The user interface 202 may also present attributes 312 associated with the first object 204(1). In some examples, the attributes 312 may include one or more set attributes that are associated with objects and/or the type of object. In some examples, the attributes 312 may include one or more attributes that are set by the user(s) of the user interface 202. While the example of FIG. 3A illustrates three attributes 312, in other examples, the user interface 202 may present any number of attributes. Additionally, while the example of FIG. 3A illustrates the attributes 312 as being presented on the right of the user interface 202, in other examples, the user interface 202 may present the attributes 312 at one or more other locations. For example, the user interface 202 may present the attributes 312 within the timeline 218 and/or with the first representation 222(1) associated with the first object 204(1).

In the example of FIG. 3A, the bounding shape 208(1), the bounding shape 214, the bounding shape 308, and/or the bounding shape 310 may not adequately represent the first object 204(1). As such, and as illustrated by the example of FIG. 3B, the user(s) may provide at least one or more first inputs to update one or more dimensions of the bounding shape 308 and one or more second inputs to update one or more dimensions of the bounding shape 308. In some examples, the updating component 118 may then use a labeling component 120 to update the bounding shape 308 to include a bounding shape 314 based at least on the first input(s) and update the bounding shape 310 to include a bounding shape 316 based at least on the second input(s). The labeling component 120 may also use the updated bounding shapes 314 and 316 to update the bounding shape 214 and/or the bounding shape 208(1) associated with the first object 204(1). For instance, the labeling component 120 may update one or more dimensions of the bounding shape 214 and/or the bounding shape 208(1) in order to respectively generate a bounding shape 318 and/or the bounding shape 320, where the dimensions of the bounding shape 318 and/or the bounding shape 320 are based on the dimensions of the bounding shapes 314 and 316.

Additionally, the user(s) may provide one or more third inputs to update the orientation associated with the bounding shape 320, such that the bounding shape 320 better represents the actual orientation of the first object 204(1) at the current time instance 224. For instance, and as shown by the example of FIG. 3A, based at least on the third input(s), the labeling component 120 may update the orientation of the bounding shape 320. In some examples, the labeling component 120 (and/or another component) may also update the trajectory to match the updated orientation of the bounding shape 208(1).

As further illustrated by the example of FIG. 3B, the user(s) may provide one or more fourth inputs to update at least the second attribute 312 associated with the first object 204(1). The labeling component 120 may then use the fourth input(s) to update the second attribute 312 from indicating that the type of vehicle includes a “car” to indicating that the type of vehicle includes a “SUV.” In some examples, the user(s) may provide additional inputs to update one or more additional attributes 312 associated with the first object 204(1), add one or more attributes 312 associated with the first object 204(1), and/or delete one or more of the attributes 312 associated with the first object 204(1).

While the example of FIGS. 3A-3B illustrate the user(s) reviewing the labels associated with the first object 204(1) for the current time instance 224, in some examples, similar processes may be performed to allow the user(s) to review labels associated with the first object 204(1) for one or more additional time instances. For example, the user(s) may begin reviewing labels associated with the first object 204(1) for a start of the time period 220, such as the starting time instance associated with the sensor data, and then review labels for one or more time instances in sequence to the end of the time period 220, such as the ending time instance associated with the sensor data. This way, the user(s) is able to at least verify and/or update the labels associated with the first object 204(1) at different time instances along the time period 220.

Referring back to the example of FIG. 1, the process 100 may then include the updating component 118 using a synchronization component 122 to update labels for one or more additional sensor representations that also represent the object. For instance, the synchronization component 122 may use the updates to the bounding shape(s) to further update one or more bounding shapes associated with the additional sensor representations that also represent the object. In some examples, the synchronization component 122 updates the additional bounding shape(s) using one or more techniques, such as by interpolating between the sensor representations and/or using the motion of the machine(s) that generated the sensor data 102. In some examples, the synchronization component 122 may update all of the sensor representations that also represent the object. However, in some examples, the synchronization component 122 may only update specific sensor representations, such as sensor representations that are within a threshold time period to the current sensor representation. For example, the synchronization component 122 may update sensor representations that were generated during a previous time period (e.g., 0.5 seconds, 1 second, 2 seconds, etc.) and/or sensor representations that were generated during a future time period (e.g., 0.5 seconds, 1 second, 2 seconds, etc.).

In some examples, in addition to, or alternatively from, updating the location information associated with the object, the synchronization component 122 may update one or more attributes associated with the object. For instance, and as described herein, multiple sensor representations that represent the object may be associated with one or more of the same attributes for the object. As such, when the user(s) updates an attribute for the object as represented by a sensor representation, the synchronization component 122 may update one or more additional sensor representations that also represent the object to also be associated with the updated attribute. Again, in some examples, the synchronization component 122 may update all of the sensor representations that also represent the object. However, in some examples, the synchronization component 122 may only update specific sensor representations, such as sensor representations that are within a threshold time period to the current sensor representation. For example, the synchronization component 122 may update sensor representations that were generated during a previous time period (e.g., 0.5 seconds, 1 second, 2 seconds, etc.) and/or sensor representations that were generated during a future time period (e.g., 0.5 seconds, 1 second, 2 seconds, etc.).

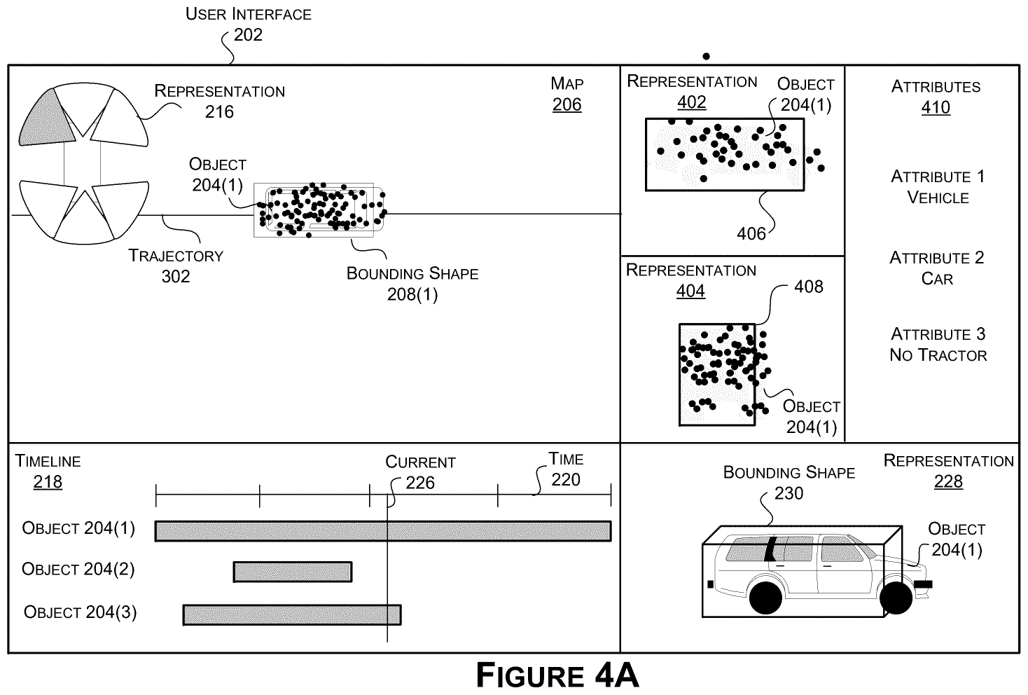

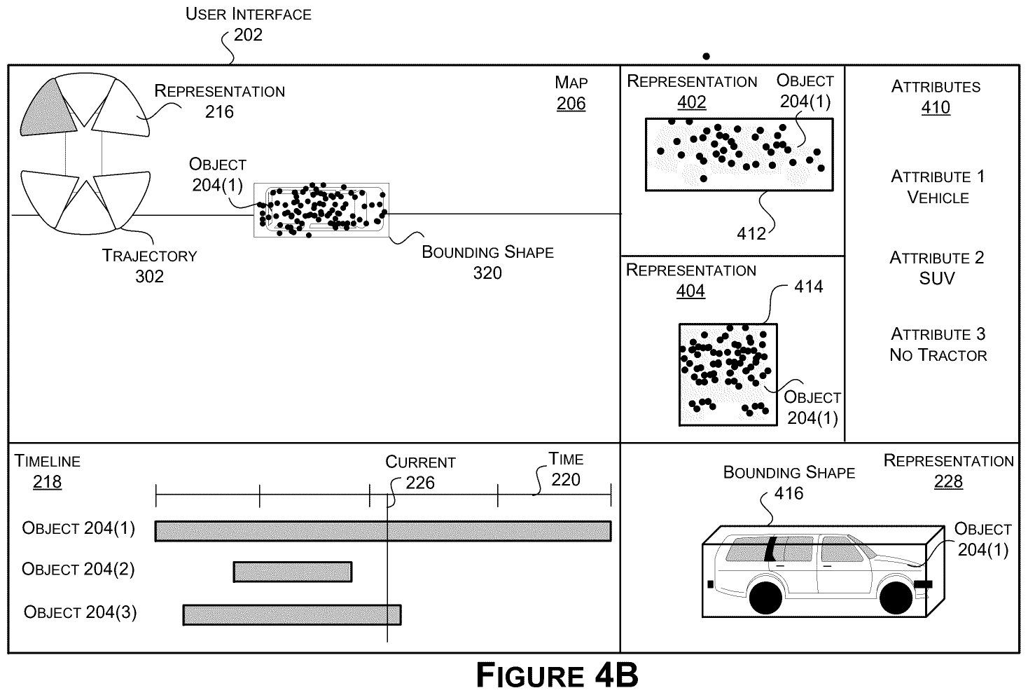

For instance, FIGS. 4A-4B illustrate an example of using updated labels for sensor representations associated with a time instance to update labels for sensor representation associated with an additional time instance, in accordance with some embodiments of the present disclosure. As shown by the example of FIG. 4A, the user interface 202 may present information associated with the current time instance 226. For instance, the user interface 202 may present the sensor representation 228 that represents the first object 204(1) at the current time instance 226. Additionally, the user interface 202 may present a sensor representation 402 associated with LiDAR data and representing the first object 204(1) in a first orientation, such as from the side, and a sensor representation 404 associated with the LiDAR data and representing the first object 204(2) in a second orientation, such as from the front or the back, where the sensor representations 402 and 404 are also associated with the current time instance 226. As shown, the sensor representation 402 may be associated with a bounding shape 406 (e.g., an initial bounding shape) associated with the first object 204(1) in the first orientation and the sensor representation 404 may be associated with a bounding shape 408 (e.g., an initial bounding shape) associated with the first object 204(2) in the second orientation. The user interface 202 may also present initial attributes 410 associated with the first object 204(1).

In the example of FIG. 4A, which is before the user(s) provided the inputs to update the labels with respect to the example of FIG. 3B, at least a portion of the labels may be incorrect. For example, the bounding shape 406 and the bounding shape 408 may not adequately represent the locations of the first object 204(1) as respectively represented by the sensor representation 402 and the sensor representation 404 (e.g., the bounding shapes 406 and 408 do not enclose all of the first object 204(1)). As such, and for similar reasons, the bounding shape 208(1) and the bounding shape 230 may not adequately represent the location of the first object 204(1) as respectively represented by the map 206 and the sensor representation 228. Additionally, in the example of FIG. 4A, the second attribute 410 may not correctly identify the type of vehicle that is associated with the first object 204(1).

As such, and as illustrated by the example of FIG. 4B, based at least on the inputs by the user(s) and/or the updates to the labels with respect to the example of FIG. 3B, the synchronization component 122 may automatically update the labels associated with the map 206 and/or the sensor representations 228, 402, and 404. For instance, and as shown, the synchronization component 122 may update the bounding shape 208(1) to include the bounding shape 320, update the bounding shape 406 to include a bounding shape 412, update the bounding shape 408 to include a bounding shape 414, and update the bounding shape 230 to include a bounding shape 416. As described herein, the synchronization component 122 may use any technique to perform the updates, such as using interpolation based at least on the motion of the machine(s) that generated the sensor data. The synchronization component 122 may also update the second attribute 410 to include “SUV.”

This way, by performing the processes described herein, the user(s) may need to only update the labels for the map 206 and/or the sensor representations 212, 304, and 306 associated with the time instance 224 and the updating component 118 will then update the labels for the map 206 and/or the sensor representations 228, 402, and 404 associated with the current time instance 226. In some examples, the updating component 118 may perform similar processes to update sensor representations associated with any number of time instances. Because of this, the user(s) may be required to provide less inputs to update the labels associated with the sensor data. Additionally, the labels associated with the sensor data may be more accurate since the labels are less prone to user error when generating and/or updating labels.

Referring back the example of FIG. 1, in some examples, the process 100 may continue such that the user(s) verifies labels, updates labels, and/or generates new labels for specific sensor representations, such as keyframes, every other frame, every tenth frame, every thirtieth frame, every sixtieth frame, every one hundredth frame, and/or any other combination of frames. The synchronization component 122 is then able to use the labels for those specific sensor representations to verify labels, update labels, and/or generate new labels for additional sensor representations. This way, the process 100 is able to generate accurate labels for an entire sequence of sensor representations associated with a drive of a machine without the user(s) having to review each of the sensor representations and/or only review just a few of the sensor representations.

In some examples, the updating component 118 may perform additional and/or alternative processes associated with the labels for the objects. For example, based at least on determining that an object was not initially labeled, the user(s) may provide one or more inputs associated with generating one or more new labels associated with the object, such as one or more labels that includes location information associated with the object and/or attributes associated with the object. The labeling component 120 may then use the input(s), which may be represented by the input data 116, to generate the new label(s) for the object.

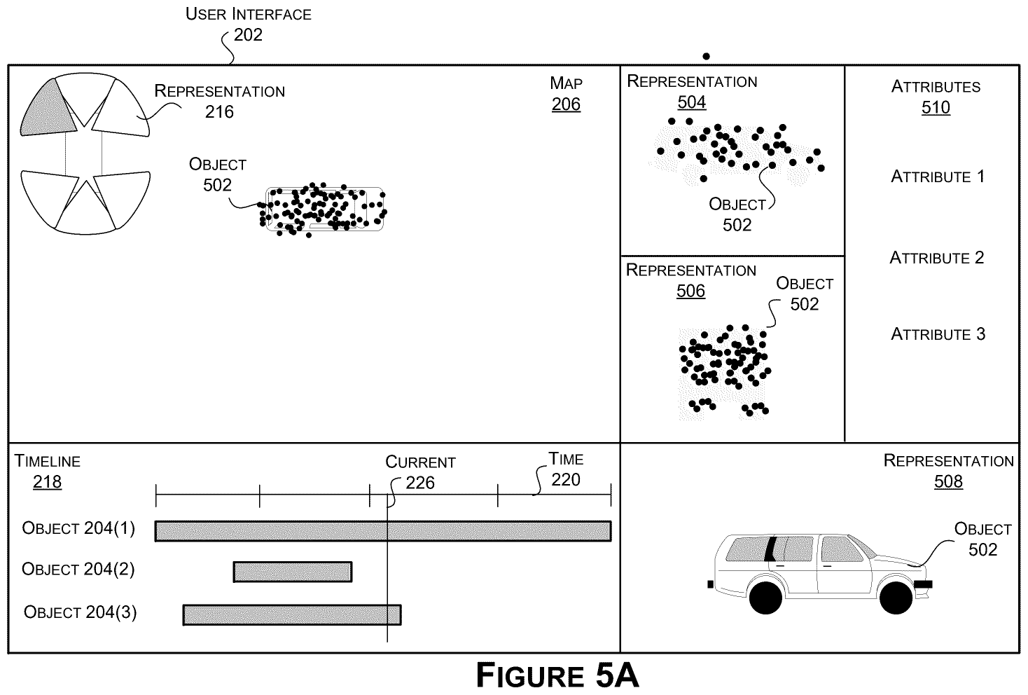

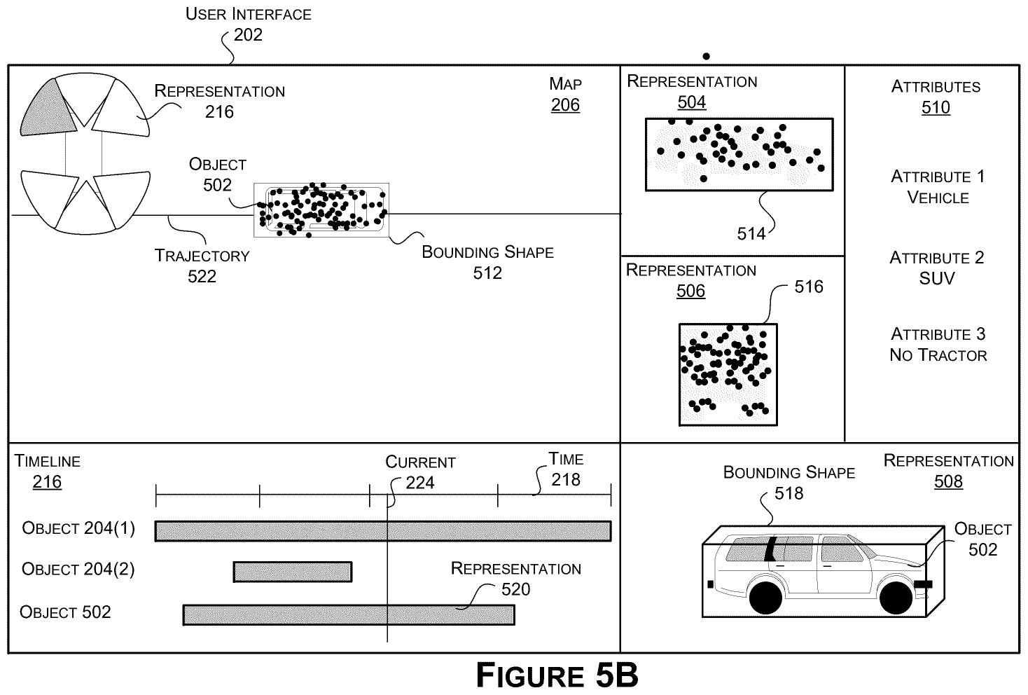

For instance, FIGS. 5A-5B illustrate an example of using a user interface to generate labels for an object, in accordance with some embodiments of the present disclosure. As shown by the example of FIG. 5A, based at least on the user(s) selecting a new object 502, the user interface 202 may represent at least a sensor representation 504 associated with LiDAR data and representing the new object 502 in a first orientation, such as from the side, a sensor representation 506 associated with the LiDAR data and representing the new object 502 in a second orientation, such as from the front or the back, and a third sensor representation 508 associated with image data and representing the new object 502. The user interface 202 may also present a list of attributes 510 that may be associated with the new object 502. As described herein, in some examples, one or more of the attributes 510 may include set attributes for objects. Additionally, or alternatively, in some examples, one or more of the attributes 510 may be set by the user(s).

Next, and as illustrated by the example of FIG. 5B, the user(s) may provide one or more inputs indicating at least a bounding shape 512 associated with the new object 502 as represented by the map 206, a bounding shape 514 associated with the new object 502 as represented by the sensor representation 504, and/or a bounding shape 516 associated with the new object 502 as represented by the sensor representation 506. As such, the labeling component 120 may use one or more of the bounding shape 512, the bounding shape 514, or the bounding shape 516 to generate a bounding shape 518 associated with the new object 502 as represented by the sensor representation 508. Additionally, in some examples, the user(s) may provide one or more inputs indicating the attributes 510 associated with the new object 502. In some examples, the user(s) may then perform similar processes in order to label additional sensor representations that also represent the object 502 and are associated with one or more additional time instances. Additionally, or alternatively, in some examples, the synchronization component 122 may then use the inputted labels to generate new labels associated with the new object 502 for additional sensor representations associated with one or more additional time instances.

As further shown by the example of FIG. 5B, the updating component 118 may update the timeline 218 to include a new representation 520 indicating a time period for which the new object 502 is detected. Additionally, the updating component 118 may update the user interface 202 to include a trajectory 522 associated with the new object 502 over the time period for which the new object 502 was detected.

Referring back to the example of FIG. 1, the process 100 may include the updating component 118 using a trajectory component 124 to determine and/or update trajectories associated with the objects. For instance, and as described herein, the updating component 118 is able to able to use labels associated with specific sensor representations, such as keyframes, to determine labels associated with other sensor representations, such as frames that are between the keyframes. This way, the updating component 118 is able to determine location information associated with the objects at multiple time instances, such as 15 time instances per second, 30 time instances per second, 60 time instances per second, and/or the like. As such, and for an object, the trajectory component 124 may use this location information to generate a trajectory (e.g., a trackline) associated with the object within the environment over a period of time, such as by connecting the locations of the object. An example of the trajectory 302 of the first object 204(1) is illustrated at least in FIGS. 3A-3B, where the trajectory 302 may be generated using location information associated with the first object 204(1) over multiple time instances.

In some examples, the process 100 may further include the trajectory component 124 updating one or more trajectories associated with one or more objects. For instance, the user(s) may indicate that an object includes a static object. As such, the trajectory component 124 may use this indication to update the trajectory for the object. For example, the trajectory component 124 may update the trajectory to include a single point within the environment.

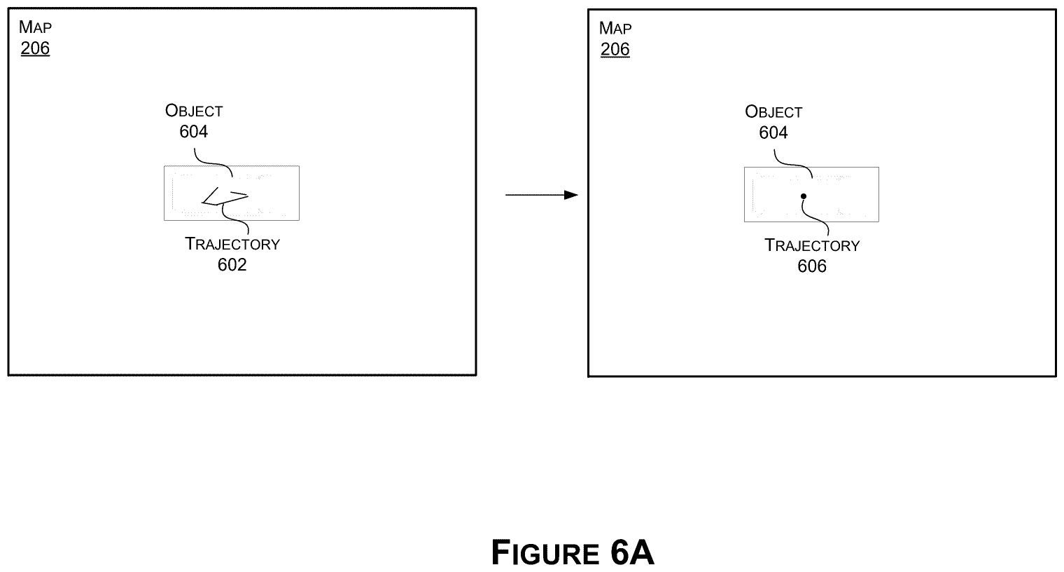

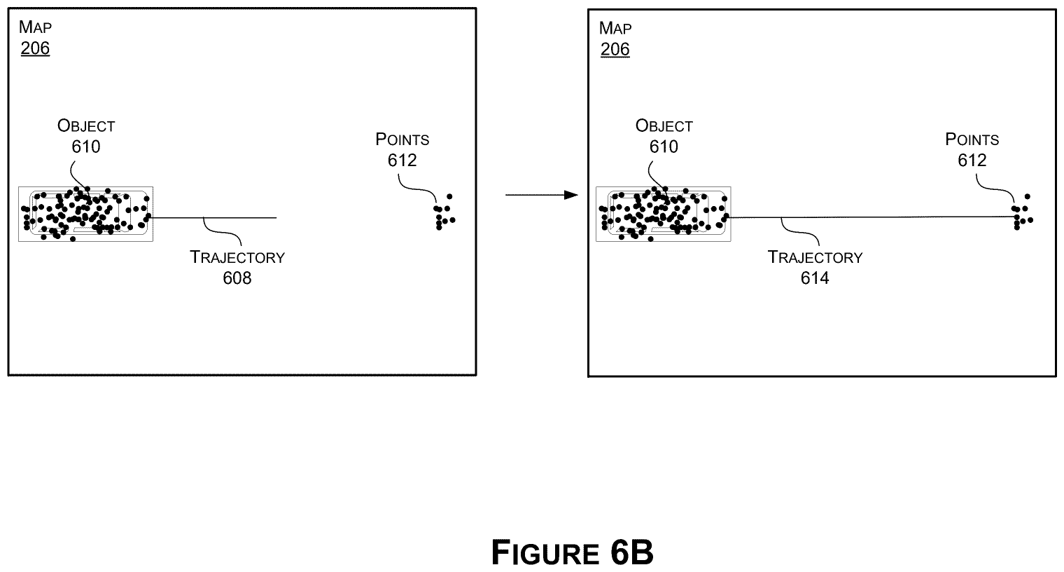

For instance, FIG. 6A illustrates an example of updating trajectory associated with an object based at least on user input, in accordance with some embodiments of the present disclosure. As shown by the left illustration, the map 206 of the user interface 202 (which is not illustrated for clarity purposes) may initially indicate a first trajectory 602 associated with an object 604. In some examples, even though the object 604 is stationary, the first trajectory 602 may indicate slight motion associated with the object 604, such as based on jitter and/or any other type of error. As such, and as shown by the right illustration, after the user(s) provides input indicating that the object 604 is static, the trajectory component 124 may update the first trajectory 602 to include a second trajectory 606. As shown, the second trajectory 606 includes a point within the environment.

Referring back to the example of FIG. 1, in some examples, the trajectory component 124 may update a trajectory associated with an object by extending the trajectory to include one or more new locations within the environment. For instance, the trajectory component 124 may determine an initial trajectory for the object. The trajectory component 124 may then determine that an additional portion of sensor data 102 is also associated with the object, where the additional portion of the sensor data 102 represents an area of the environment that is outside of the trajectory. In some examples, the trajectory component 124 may make the determination based on receiving one or more inputs from the user(s). For example, the input(s) may indicate that one or more points associated with the map are also associated with the object. Based at least on determining that the additional portion of the sensor data 102 is also associated with the object, the trajectory component 124 may then extend the trajectory associated with the object.

For instance, FIG. 6B illustrates another example of updating a trajectory associated with an object based at least on user input, in accordance with some embodiments of the present disclosure. As shown by the left illustration, the map 206 of the user interface 202 (which is not illustrated for clarity purposes) may initially indicate a first trajectory 608 associated with an object 610. However, the trajectory component 124 may further determine that points 612 are also associated with the object 610. In some examples, the trajectory component 124 may make the determination based at least on receiving one or more inputs from the user(s). As such, and as shown by the right illustration, the trajectory component 124 may then update the first trajectory 608 to include a second trajectory 614 that further extends to the points 612. In some examples, the updating component 118 may update additional information associated with the object 610 along with the second trajectory 614, such as the timeline associated with the object 610 to indicate that the object 610 was detected for a longer period of time.

Referring back to the example of FIG. 1, based at least on performing one or more of the processes described herein, the updating component 118 may generate and/or output updated labels data 126 representing new labels, updated labels, and/or indications that labels were deleted. Additionally, the interface component 110 may use the updated labels data 126 to then update the user interface(s) to include the updated labels. The process 100 may then continue repeat such that the user(s) and/or the updating component 118 is able to continue updating the labels associated with the sensor data 102.

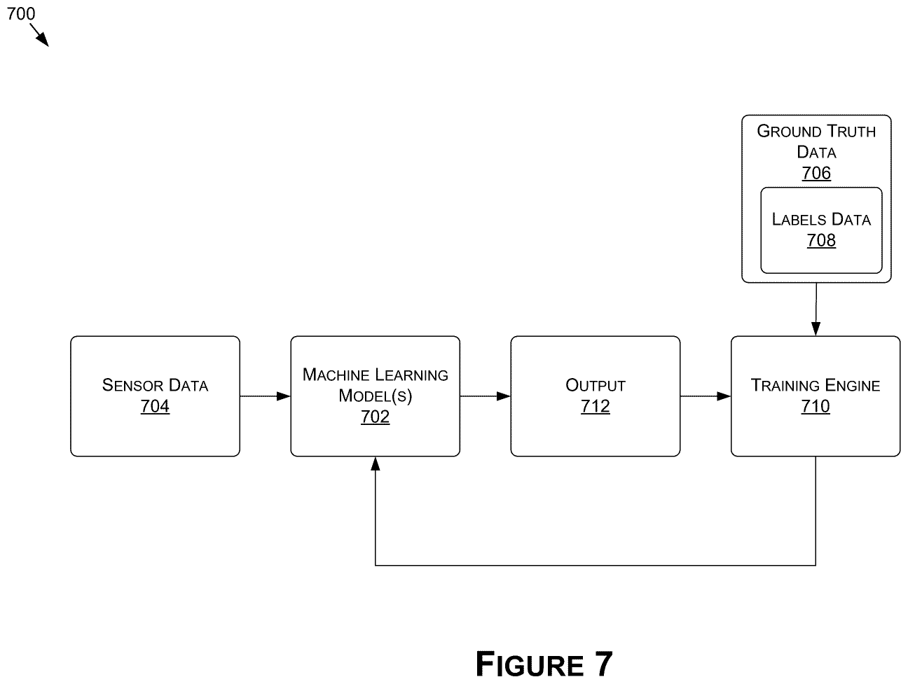

As described herein, in some examples, the labeled sensor data 102 may be used to train one or more models to perform one or more tasks. As such, in such examples, the labels data 108 and/or the updated labels data 126 may correspond to ground truth data (e.g., ground truth labels) for the sensor data 102 that is used to train the model(s). For instance, FIG. 7 illustrates a data flow diagram illustrating a process 700 for training one or more machine learning models 702 to perform one or more tasks, in accordance with some embodiments of the present disclosure. As described herein, the task(s) may include, object recognition, object tracking, trajectory planning, machine localization, and/or any other task for which the machine learning model(s) 702 may be trained.

As shown, the machine learning model(s) 702 may be trained using sensor data 704 (which may represent, and/or include, the sensor data 102). When including image data, the sensor data 704 used for training may include original images (e.g., as captured by one or more image sensors), down-sampled images, up-sampled images, cropped or region of interest (ROI) images, otherwise augmented images, and/or a combination thereof. The sensor data 704 may be images captured by one or more sensors (e.g., the sensor(s) 104) of various machines, and/or may be images captured from within a virtual environment used for testing and/or generating training images (e.g., a virtual camera of a virtual machine within a virtual or simulated environment). In some examples, the sensor data 704 may include images from a data store or repository of training images (e.g., images of driving surfaces).

The machine learning model(s) 702 may be trained using the sensor data 704 as well as corresponding ground truth data 706. The ground truth data 706 may include annotations, labels, masks, and/or the like. For example, in some embodiments, the ground truth data 706 may include labels data 708. As described herein, in some examples, the labels data 708 may represent, and/or include, the labels data 108 and/or the updated labels data 126. The ground truth data 706 may be generated using the process 100 and/or within a drawing program (e.g., an annotation program), a computer aided design (CAD) program, a labeling program, another type of program suitable for generating the ground truth data 706, and/or may be hand drawn, in some examples. In any example, the ground truth data 706 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some examples, for each input image, there may be corresponding ground truth data 706.

A training engine 710 may include one or more loss functions that measure loss (e.g., error) in the outputs 712 as compared to the ground truth data 706. Any type of loss function may be used, such as cross entropy loss, mean squared error, mean absolute error, mean bias error, and/or other loss function types. In some embodiments, different outputs 712 may have different loss functions. In such examples, the loss functions may be combined to form a total loss, and the total loss may be used to train (e.g., update the parameters of) the machine learning model(s) 702. In any example, backward pass computations may be performed to recursively compute gradients of the loss function(s) with respect to training parameters. In some examples, weight and biases of the machine learning model(s) may be used to compute these gradients.

In some examples, the machine learning model(s) 702 may include any model that is configured to perform one or more of the tasks described herein. For example, the machine learning model(s) 702 may include a feedforward neural network, a perceptron neural network, a multilayer perceptron neural network, a recurrent neural network, a convolution neural network, a deep stacking neural network, a large language model, and/or any other type of network.

For example, the machine learning model(s) 702 may include a number of layers. For instance, one or more of the layers may include an input layer. The input layer may hold values associated with the sensor data 704. For example, when the sensor data 704 is an image(s), the input layer may hold values representative of the raw pixel values of the image(s) as a volume (e.g., a width, W, a height, H, and color channels, C (e.g., RGB), such as 32.times.32.times.3), and/or a batch size, B (e.g., where batching is used).

One or more layers may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32.times.32.times.12, if 12 were the number of filters).

One or more of the layers may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers may include a pooling layer. The pooling layer may perform a down-sampling operation along the spatial dimensions (e.g., the height and the width), which may result in a smaller volume than the input of the pooling layer (e.g., 16.times.16.times.12 from the 32.times.32.times.12 input volume). In some examples, the machine learning model(s) 138 may not include any pooling layers. In such examples, other types of convolution layers may be used in place of pooling layers.

One or more of the layers may include a fully connected layer. Each neuron in the fully connected layer(s) may be connected to each of the neurons in the previous volume. The fully connected layer may compute class scores, and the resulting volume may be 1.times.1.times.number of classes. In some examples, the machine learning model(s) 702 may include a fully connected layer, while in other examples, the fully connected layer of the machine learning model(s) 702 may be the fully connected layer to one or more feature extractor layers. In some examples, no fully connected layers may be used by the machine learning model(s) 702, in an effort to increase processing times and reduce computing resource requirements. In such examples, where no fully connected layers are used, the machine learning model(s) 702 may be referred to as a fully convolutional network.

One or more of the layers may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the sensor data 704) to the machine learning model(s) 138, or used to up-sample to the input spatial resolution of a next layer.

Although input layers, convolutional layers, pooling layers, ReLU layers, deconvolutional layers, and fully connected layers are discussed herein with respect to the layers of the machine learning model (s 138, this is not intended to be limiting. For example, additional or alternative layers may be used in the machine learning model(s) 702, such as normalization layers, SoftMax layers, and/or other layer types.

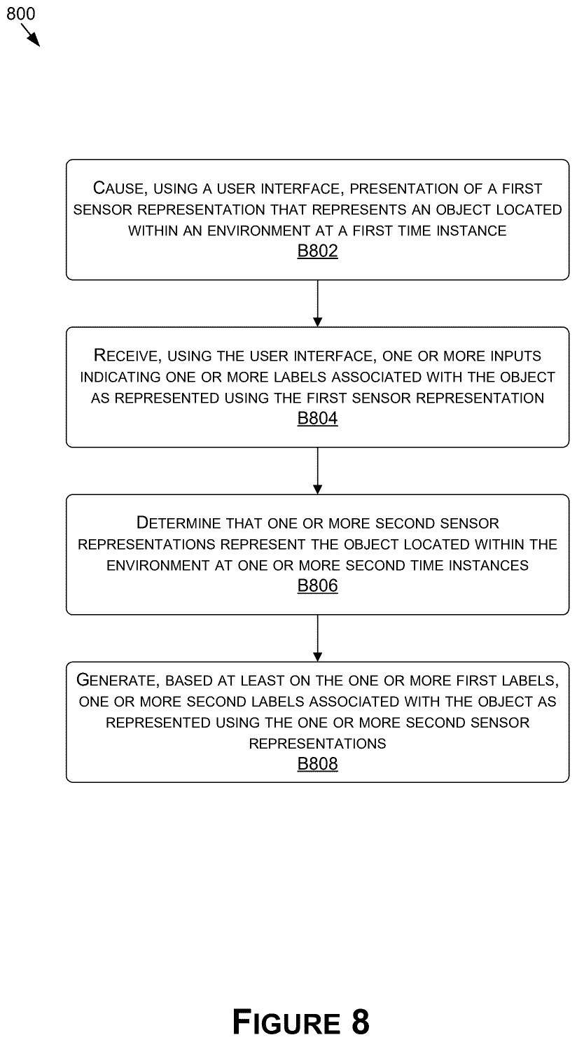

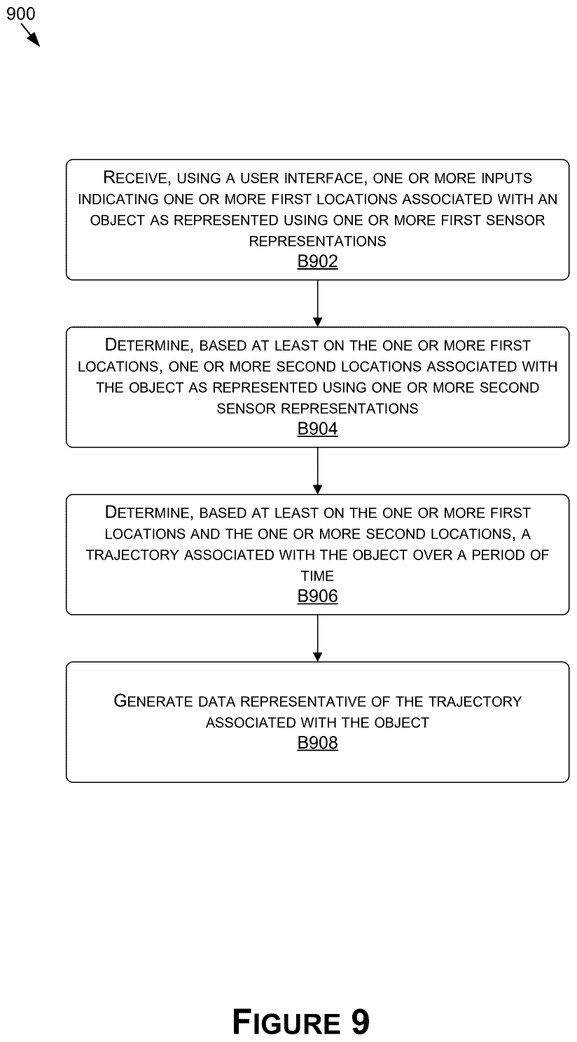

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, the methods 800 and 900 are described, by way of example, with respect to FIG. 1. However, these methods 800 and 900 may additionally or alternatively be executed by any one system, or any combination of systems, including, but not limited to, those described herein.

FIG. 8 illustrates a flow diagram showing a method 800 for automatically labeling sensor representations corresponding to an object, in accordance with some embodiments of the present disclosure. The method 800, at block B802, may include causing, using a user interface, presentation of a first sensor representation that represents an object located within an environment at a first time instance. For instance, the interface component 110 and/or the updating component 118 may cause the user device(s) 114 to present the user interface, where the user interface presents at least the first sensor representation (e.g., a first frame). In some examples, the first sensor representation may include an initial bounding shape associated with the object, where the initial bounding shape may be determined using the labeling component(s) 106. In some examples, the user interface may further present one or more additional sensor representations that also represent the object, a map representing a location of the object within the environment at the first time instance, and/or one or more initial attributes associated with the object.

The method 800, at block B804, may include receiving, using the user interface, one or more inputs indicating one or more first labels associated with the object as represented using the first sensor representation. For instance, the updating component 118 may receive the input data 116 representing the input(s) indicating a first bounding shape associated with the object, where the input(s) is represented by the input data 116. In some examples, the input(s) may be associated with updating one or more dimensions of the initial bounding shape associated with the object to include the first bounding shape. Based at least on the input(s), the labeling component 120 may then generate the first bounding shape associated with the object. In some examples, the labeling component 120 may also update one or more additional bounding shapes associated with the additional sensor representation(s). Additionally, in some examples, the labeling component 120 may update one or more additional labels using the input(s), such as one or more attributes associated with the object.

The method 800, at block B806, may include determining that one or more second sensor representations represent the object located within the environment at one or more second time instances. For instance, the synchronization component 122 may determine that the second sensor representation(s) also represents the object. In some examples, the synchronization component 122 may make the determination based at least on the second sensor representation(s) being labeled as including the object. As described herein, the second sensor representation(s) may be generated before the first sensor representation and/or after the first sensor representation.

The method 800, at block B808, may include generating, based at least on the one or more first labels, one or more second labels associated with the object as represented using the one or more second sensor representations. For instance, the synchronization component 122 may generate the second bounding shape(s) for the object using the first bounding shape. As described herein, in some examples, the synchronization component 122 may generate the second bounding shape(s) using interpolation. In some examples, the synchronization component 122 may also generate one or more attributes associated with the second sensor representation(s) based at least on the attribute(s) associated with the first sensor representation. For instance, if the user(s) updates an attribute associated with the first sensor representation, then the synchronization component 122 may update the same attribute associated with the second sensor representation(s).

FIG. 9 illustrates a flow diagram showing a method 900 for using automatically determined labels to determine a trajectory associated with an object, in accordance with some embodiments of the present disclosure. The method 900, at block B902, may include receiving, using a user interface, one or more inputs indicating one or more first locations associated with an object as represented using one or more first sensor representations. For instance, the updating component 118 may receive the input data 116 representing of the input(s) indicating the first location(s) associated with the object as represented using the first sensor representation(s). As described herein, the first sensor representation(s) may be associated with one or more first time instances. Additionally, the input(s) may be associated with the user(s) labeling the first sensor representation(s) using the user interface.

The method 900, at block B904, may include determining, based at least on the one or more first locations, one or more second locations associated with the object as represented using one or more second sensor representations. For instance, the synchronization component 122 may use the first location(s) associated with the object to automatically determine the second location(s) associated with the object as represented using the second sensor representation. As described herein, the second sensor representation(s) may be associated with one or more second time instances. Additionally, in some examples, the synchronization component 122 may determine the second location(s) using one or more techniques, such as interpolation.

The method 900, at block B906, may include determining, based at least on the one or more first locations and the one or more second locations, a trajectory associated with the object over a period of time. For instance, the trajectory component 124 may use at least the first location(s) and the second location(s) to determine the trajectory associated with the object over the period of time, where the period of time includes at least the first time instance(s) and the second time instance(s). As described herein, by using the first location(s) input by the user(s) and the second location(s) automatically determined for the second sensor representation(s), the trajectory component 124 may include enough locations to determine a smooth trajectory associated with the object as compared to just using the first location(s) input by the user(s).

The method 900, at block B908, may include generating data representative of the trajectory associated with the object. For instance, the trajectory component 124 may generate the updated labels data 126 and/or training data representing the trajectory. Additionally, in some examples, the updating component 118 may cause the user interface to present the trajectory associated with the object.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE CLAUSES

A: A method comprising: causing, using a user interface, presentation of a first sensor representation that represents an object located within an environment at a first time instance; receiving, using the user interface, input data representative of one or more inputs indicating a first bounding shape associated with the object as represented using the first sensor representation; determining that one or more second sensor representations represent the object located within the environment at one or more second time instances; and based at least on the first bounding shape, generating one or more second bounding shapes associated with the object as represented using the one or more second sensor representations.

B: The method of paragraph A, further comprising: causing, using the user interface, presentation of an initial bounding shape associated with the object as represented using the first sensor representation; and updating, based at least on the input data, the initial bounding shape to include the first bounding shape associated with the object.

C: The method of either paragraph A or paragraph B, wherein: the one or more second sensor representations are associated with one or more initial bounding shapes associated with the object; and the generating the one or more second bounding shapes associated with the object as represented using the one or more second sensor representations comprises updating, based at least on the first bounding shape, the one or more initial bounding shapes to include the one or more second bounding shapes.

D: The method of any one of paragraphs A-C, further comprising: causing, using the user interface, presentation of a map that includes a third bounding shape indicating a first orientation of the object within the environment at the first time instance; receiving, using the user interface, second input data representative of one or more second inputs associated with adjusting the first orientation; and updating, based at least on the second input data, the third bounding shape to indicate a second orientation of the object within the environment at the first time instance.

E: The method of any one of paragraphs A-D, further comprising: causing, using the user interface, presentation of a map that indicates a trajectory associated with the object between at least the first time instance and the one or more second time instances, wherein: the first sensor representation is associated with a first point along with the trajectory; and the one or more second sensor representations are associated with one or more second points along the trajectory.

F: The method of any one of paragraphs A-E, further comprising: causing, using the user interface, presentation of a timeline that includes one or more representations associated with one or more objects detected within the environment over one or more periods of time, the one or more objects including at least the object; and receiving, using the user interface, second input data representative of one or more second inputs indicating a selection associated with a representation, of the one or more representations, that is associated with the object, wherein the causing the presentation of the first sensor representation is based at least on the selection.

G: The method of any one of paragraphs A-F, further comprising: receiving, using the user interface, second input data representative of one or more second inputs indicating one or more attributes associated with the object as represented using the first sensor representation; and causing, based at least on the second input data, the one or more attributes to also be associated with the object as represented using the one or more second sensor representations.

H: The method of any one of paragraphs A-G, further comprising: causing, using the user interface, presentation of a map that indicates a trajectory associated with the object; receiving, using the user interface, second input data representative of one or more second inputs indicating that one or more points on the map are also associated with the object; and causing, based at least on the second input data, the trajectory to extend to a location within the environment that is associated with the one or more points.

I: The method of any one of paragraphs A-H, further comprising: causing, using the user interface and along with the first sensor representation, presentation of a third sensor representation that represents the object located within the environment at the first time instance, wherein the first sensor representation is associated with a first type of sensor data and the second sensor representation is associated with a second type of sensor data; and based at least on the first bounding shape, generating a third bounding shape associated with the object as represented using the third sensor representation.

J: The method of any one of paragraphs A-I, further comprising causing, using the user interface and along with the first sensor representation, presentation of a map of the environment, the map including: one or more first points represented by first sensor data generated at the first time instance, the one or more first points including one or more first characteristics; and one or more second points represented by second sensor data generated at the one or more second time instances, the one or more second points including one or more second characteristics that differ from the one or more first characteristics.

K: A system comprising: one or more processors to: cause, using a user interface, presentation of one or more first sensor representations that represents an object or a feature located within an environment at a first time instance; receive, using the use interface, input data representative of one or more inputs indicating one or more first labels associated with the object or the feature as represented using the one or more first sensor representations; determine that one or more second sensor representations represent the object or the feature located within the environment at one or more second time instances; and based at least on the one or more first labels, cause one or more second labels to further be associated with the object or the feature as represented using the one or more second sensor representations.

L: The system of paragraph K, wherein: the one or more first labels include one or more first bounding shapes associated with the object or the feature as represented using the one or more first sensor representations; and the one or more second labels include one or more second bounding shapes associated with the object or the feature as represented using the one or more second sensor representations.

M: The system of either paragraph K or paragraph L, wherein: the one or more first labels include one or more attributes associated with the object or the feature as represented using the one or more first sensor representations; and the one or more second labels include one or more second attributes associated with the object or the feature as represented using the one or more second sensor representations.

N: The system of any one of paragraph K-M, wherein the one or more processors are further to: cause, using the user interface, presentation of a map that includes a third label indicating a first orientation of the object or the feature within the environment at the first time instance; receive, using the user interface, second input data representative of one or more second inputs associated with adjusting the first orientation; and update, based at least on the second input data, the third label to indicate a second orientation of the object or the feature within the environment at the first time instance.

O: The system of paragraph N, wherein: the map further indicates a trajectory associated with the object or the feature between the first time instance and the one or more second time instances; and the one or more processors are further to update, based at least on the second orientation, the trajectory associated with the object or the feature as indicated by the map.

P: The system of any one of paragraphs K-O, wherein the one or more processors are further to: cause, using the user interface, presentation of a timeline that includes one or more representations associated with one or more objects or one or more features detected within the environment over one or more periods of time, the one or more objects or the one or more features including at least the object or the feature; and receive, using the user interface, second input data representative of one or more second inputs indicating a selection associated with a representation, of the one or more representations, that is associated with the object or the feature, wherein the one or more first sensor representations are presented based at least on the selection.

Q: The system of any one of paragraphs K-P, wherein the one or more processors are further to: cause, using the user interface, presentation of one or more initial labels associated with the object or the feature as represented using the one or more first sensor representations; and update, based at least on the input data, the one or more initial labels to include the one or more first labels associated with the object or the feature.

R: The system of any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to update one or more first labels corresponding an object or a feature as represented using one or more first sensor representations associated with one or more first time instances based at least on one or more second labels corresponding to the object or the feature as represented using one or more second sensor representations associated with one or more second time instances, wherein the one or more second labels are determined based at least on receiving one or more inputs using a user interface that is presenting the one or more second sensor representations.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Any, some and/or all features in one aspect of the disclosure may be applied to other aspects of the disclosure, in any appropriate combination or sub-combination. In particular, device aspects may be applied to method aspects, and vice versa. It should also be appreciated that particular combinations of the various features described and defined in any aspect or embodiment of the disclosure can be implemented and/or supplied and/or used independently.

The various features described in the description as optional-such as by use of “may” or “can”—may be combined into a single embodiment, and/or any combination of the features may be combined to form various embodiments that rely on the combination of these various optional features.

What is claimed is:

1. A method comprising:
causing, using a user interface, presentation of a first sensor representation that represents an object located within an environment at a first time instance;
receiving, using the user interface, input data representative of one or more inputs indicating a first bounding shape associated with the object as represented using the first sensor representation;
determining that one or more second sensor representations represent the object located within the environment at one or more second time instances; and
based at least on the first bounding shape, generating one or more second bounding shapes associated with the object as represented using the one or more second sensor representations.

2. The method of claim 1, further comprising:
causing, using the user interface, presentation of an initial bounding shape associated with the object as represented using the first sensor representation; and
updating, based at least on the input data, the initial bounding shape to include the first bounding shape associated with the object.

3. The method of claim 1, wherein:
the one or more second sensor representations are associated with one or more initial bounding shapes associated with the object; and
the generating the one or more second bounding shapes associated with the object as represented using the one or more second sensor representations comprises updating, based at least on the first bounding shape, the one or more initial bounding shapes to include the one or more second bounding shapes.

4. The method of claim 1, further comprising:
causing, using the user interface, presentation of a map that includes a third bounding shape indicating a first orientation of the object within the environment at the first time instance;
receiving, using the user interface, second input data representative of one or more second inputs associated with adjusting the first orientation; and
updating, based at least on the second input data, the third bounding shape to indicate a second orientation of the object within the environment at the first time instance.

5. The method of claim 1, further comprising:
causing, using the user interface, presentation of a map that indicates a trajectory associated with the object between at least the first time instance and the one or more second time instances,
wherein:
the first sensor representation is associated with a first point along with the trajectory; and
the one or more second sensor representations are associated with one or more second points along the trajectory.

6. The method of claim 1, further comprising:
causing, using the user interface, presentation of a timeline that includes one or more representations associated with one or more objects detected within the environment over one or more periods of time, the one or more objects including at least the object; and
receiving, using the user interface, second input data representative of one or more second inputs indicating a selection associated with a representation, of the one or more representations, that is associated with the object,
wherein the causing the presentation of the first sensor representation is based at least on the selection.

7. The method of claim 1, further comprising:
receiving, using the user interface, second input data representative of one or more second inputs indicating one or more attributes associated with the object as represented using the first sensor representation; and
causing, based at least on the second input data, the one or more attributes to also be associated with the object as represented using the one or more second sensor representations.

8. The method of claim 1, further comprising:
causing, using the user interface, presentation of a map that indicates a trajectory associated with the object;
receiving, using the user interface, second input data representative of one or more second inputs indicating that one or more points on the map are also associated with the object; and
causing, based at least on the second input data, the trajectory to extend to a location within the environment that is associated with the one or more points.

9. The method of claim 1, further comprising:
causing, using the user interface and along with the first sensor representation, presentation of a third sensor representation that represents the object located within the environment at the first time instance, wherein the first sensor representation is associated with a first type of sensor data and the second sensor representation is associated with a second type of sensor data; and
based at least on the first bounding shape, generating a third bounding shape associated with the object as represented using the third sensor representation.

10. The method of claim 1, further comprising causing, using the user interface and along with the first sensor representation, presentation of a map of the environment, the map including:
one or more first points represented by first sensor data generated at the first time instance, the one or more first points including one or more first characteristics; and
one or more second points represented by second sensor data generated at the one or more second time instances, the one or more second points including one or more second characteristics that differ from the one or more first characteristics.

11. A system comprising:
one or more processors to:
cause, using a user interface, presentation of one or more first sensor representations that represents an object or a feature located within an environment at a first time instance;
receive, using the use interface, input data representative of one or more inputs indicating one or more first labels associated with the object or the feature as represented using the one or more first sensor representations;
determine that one or more second sensor representations represent the object or the feature located within the environment at one or more second time instances; and
based at least on the one or more first labels, cause one or more second labels to further be associated with the object or the feature as represented using the one or more second sensor representations.

12. The system of claim 11, wherein:
the one or more first labels include one or more first bounding shapes associated with the object or the feature as represented using the one or more first sensor representations; and
the one or more second labels include one or more second bounding shapes associated with the object or the feature as represented using the one or more second sensor representations.

13. The system of claim 11, wherein:
the one or more first labels include one or more attributes associated with the object or the feature as represented using the one or more first sensor representations; and
the one or more second labels include one or more second attributes associated with the object or the feature as represented using the one or more second sensor representations.

14. The system of claim 11, wherein the one or more processors are further to:
cause, using the user interface, presentation of a map that includes a third label indicating a first orientation of the object or the feature within the environment at the first time instance;
receive, using the user interface, second input data representative of one or more second inputs associated with adjusting the first orientation; and
update, based at least on the second input data, the third label to indicate a second orientation of the object or the feature within the environment at the first time instance.

15. The system of claim 14, wherein:
the map further indicates a trajectory associated with the object or the feature between the first time instance and the one or more second time instances; and
the one or more processors are further to update, based at least on the second orientation, the trajectory associated with the object or the feature as indicated by the map.

16. The system of claim 11, wherein the one or more processors are further to:
cause, using the user interface, presentation of a timeline that includes one or more representations associated with one or more objects or one or more features detected within the environment over one or more periods of time, the one or more objects or the one or more features including at least the object or the feature; and
receive, using the user interface, second input data representative of one or more second inputs indicating a selection associated with a representation, of the one or more representations, that is associated with the object or the feature,
wherein the one or more first sensor representations are presented based at least on the selection.

17. The system of claim 11, wherein the one or more processors are further to:
cause, using the user interface, presentation of one or more initial labels associated with the object or the feature as represented using the one or more first sensor representations; and
update, based at least on the input data, the one or more initial labels to include the one or more first labels associated with the object or the feature.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to update one or more first labels corresponding an object or a feature as represented using one or more first sensor representations associated with one or more first time instances based at least on one or more second labels corresponding to the object or the feature as represented using one or more second sensor representations associated with one or more second time instances, wherein the one or more second labels are determined based at least on receiving one or more inputs using a user interface that is presenting the one or more second sensor representations.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
